(19) United States
(12) Patent Application Publication
(10) Pub. No.: US 2009/0075544 A1
(43) Pub. Date: Mar. 19, 2009

(54) Multi-compatible sizing composition for thermosetting resins

(76) Inventors: Jean-Jacques Ruelle, Soumagne (BE); Yves Bodeux, Jalhay (BE); Marc Cossement, Poueur (BE); Claude M. Renaud, Herve (BE)

Correspondence Address: OWENS CORNING, 2790 COLUMBUS ROAD, GRANVILLE, OH, 43023, US

(21) Appl. No.: 11/901,437

(22) Filed: Sep. 17, 2007

(51) Int. Cl. D03D 15/00; C08L 41/00; B32B 27/00

(52) U.S. Cl. 442/301; 524/852; 428/411.1

(57) ABSTRACT

A multi-compatible sizing composition that includes an epoxy resin emulsion, a silane coupling agent package, a non-ionic lubricant, and a crystalline polyol is provided. The epoxy resin desirably has an epoxy equivalent weight from 180-195. A preferred emulsifier is a modified polyethylene oxide-polypropylene oxide block copolymer. The silane coupling agent package includes an aminosilane and a vinyl silane coupling agent. The sizing composition may be used equally well with epoxy, unsaturated polyester, and vinylester thermosetting resins. Reinforcement fibers sized with the inventive sizing composition possess low friction on contact points, low fuzz, and reduced drag. Other performance characteristics such as in-plane shear and dynamic fatigue are also improved by the multi-compatible sizing composition. Fibers sized with the multi-compatible sizing composition may be used, for example, to form woven rovings and fabrics, in filament winding applications, and in pultrusion processes.

### TECHNICAL FIELD AND INDUSTRIAL APPLICABILITY OF THE INVENTION

The present invention relates generally to a sizing composition for a reinforcing fiber material, and more particularly, to a sizing composition that is compatible with epoxy, unsaturated polyester, and vinylester thermosetting resins.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. Typically, glass fibers are formed by attenuating streams of a molten glass material from a bushing. An aqueous sizing composition, or chemical treatment, is typically applied to the fibers after they are drawn from the bushing. The sizing composition protects the fibers from interfilament abrasion and promotes compatibility and adhesion between the glass fibers and the matrix in which the glass fibers are to be used. After the fibers are treated with the aqueous sizing composition, they may be dried and formed into a continuous fiber strand package or chopped into chopped strand segments.

Conventional sizing compositions typically contain one or more film forming polymeric or resinous components, glass-resin coupling agents, and one or more lubricants dissolved or dispersed in a liquid medium. The film forming component of the size composition is desirably selected to be compatible with the matrix resin or resins in which the glass fibers are to be embedded. Epoxy film formers are utilized in the sizing compositions of a wide variety of reinforcement systems for numerous resin systems. Specific examples of sizing compositions that contain epoxy resins are set forth below.

U.S. Pat. No. 4,104,434 to Johnson describes a sizing composition that contains a water emulsifiable resin system such as an epoxy resin, an aliphatic monocarboxylic acid, and an aliphatic polycarboxylic acid.

U.S. Pat. No. 4,107,118 to McCoy describes a glass sizing composition that contains an epoxy resin emulsion, a polyvinylpyrrolidone, and a polyethylene glycol ester monooleate. It is asserted that the sizing composition is particularly suitable for use in epoxy filament winding.

U.S. Pat. No. 4,140,833 to McCoy discloses a glass sizing composition that includes an epoxy resin emulsion, a polyvinylpyrrolidone, α-methacryloxypropyltriethoxysilane, and a polyethylene glycol ester monostearate. It is asserted that the sizing composition is particularly suitable for continuous pultrusion.

U.S. Patent No. 4,305,742 to Barch et al. discloses a sizing composition for treating glass fibers that includes a phenolic epoxy resin, the reaction product of a partial ester of polycarboxylic acid that contains one or more unesterified carboxyl groups with a compound containing more than one epoxy group, a lubricant, emulsifiers or wetting agents, one or more silane coupling agents, and water.

U.S. Pat. No. 4,394,418 to Temple describes an aqueous sizing composition that includes a polyvinyl acetate silane copolymer, an epoxy polymer, one or more lubricants, an organosilane coupling agent, one or more non-ionic surfactants, a hydrocarbon acid, and water. The organosilane coupling agent may be an amino-organosilane coupling agent, a lubricant modified aminosilane coupling agent, an epoxy containing silane coupling agent, or a mixture of two or more of these coupling agents. Optionally, the sizing composition may also include a polyethylene-containing polymer, and/or a wax.

U.S. Pat. No. 4,448,910 to Haines et al. discloses an aqueous sizing composition for glass fibers that contains an emulsified epoxy resin, a lubricant, and 3-chloropropyltrimethoxysilane.

U.S. Pat. No. 4,448,911 to Haines et al. describes an aqueous sizing composition for glass fibers that has an emulsified epoxy resin as the film former, an emulsified mineral oil as the lubricant, glycidoxyalkyl and/or haloalkylsilanes as coupling agents, an amide antistatic agent, and polyvinylpyrrolidone.

U.S. Pat. No. 5,417,245 to Spain discloses a composition that includes an epoxy resin and an effective amount of a non-ionic emulsifier in the form of a block polymer consisting of a poly(oxypropylene) chain having poly(oxyethylene) groups added to both ends of the chain, terminating in a primary hydroxyl group. The polymer has a molecular weight from about 1100 to about 14,000 or more.

U.S. Pat. No. 4,656,084 to McCoy et al. discloses an aqueous sizing composition for glass fibers that contains epoxy- and methacryloxy-functional organosilanes, a fiber forming polymer such as an epoxy resin, a lubricant, and a pH regulator. McCoy et al. teach that the sizing composition is particularly suitable for glass fiber reinforcements for filament winding and pultrusion applications.

U.S. Pat. No. 4,933,381 to Hager discloses a size composition for sizing small diameter glass fibers. The sizing composition includes an epoxy film former resin, a non-ionic lubricant, a cationic lubricant, at least one organosilane coupling agent, at least one volatile or non-volatile acid, and water.

U.S. Pat. No. 5,038,555 to Wu et al. discloses a size composition that includes an epoxy as the film former, at least one emulsifying agent, at least one fiber lubricant, at least one organofunctional metallic coupling agent, polyvinylpyrrolidone, a water dispersible or emulsifiable polyethylene, and water.

U.S. Pat. No. 5,262,236 to Brannon describes an aqueous size composition for glass fibers that includes an epoxy resin, a coupling agent, and crystalline pentaerythritol. Brannon asserts that the sizing composition is particularly suitable for glass fiber reinforcements for filament winding and pultrusion applications.

U.S. Pat. No. 6,228,281 to Sage describes a sizing composition for glass and carbon fibers that includes a low concentration of a cationic and non-ionic lubricant, a film forming polymer, and preferably, a coupling agent and hydrolyzing agent. It is asserted that the use of the size composition reduces fuzz development, increases wettability, and improves roving package stability.

U.S. Pat. No. 6,270,897 to Flautt et al. discloses a sizing composition that contains a combination of at least one diol organosilane and at least one triol organosilane. The sizing composition may also contain film-forming polymeric materials such as epoxy resins and lubricants.

U.S. Patent Publication Nos. 2005/0279140 and 2006/0036003 to Adzima, et al. teach a sizing composition that contains an epoxy film former, a silane package that includes an aminosilane coupling agent and an epoxy silane coupling agent, a cationic lubricant, a non-ionic lubricant, an antistatic agent, and at least one acid. The epoxy resin emulsion contains a low molecular weight epoxy resin and one or more surfactants. The epoxy resin preferably has an epoxy equivalent weight from 185-192. Optionally, the size composition may include polyurethane or epoxy/polyurethane film formers.

In addition to improving the processability of the fiber and the fiber-resin coupling, the size composition should also enhance the physical properties of the product formed from the reinforced fiber. Accordingly, in view of the dual role of the sizing compositions in improving the processability of the fibers while improving the physical properties of the formed product and the wide variety of polymeric materials that can be reinforced with reinforcing fibers such as glass fibers, there exists a need in the art for sizing compositions that provide enhanced physical properties and processing characteristics for multiple polymeric resins.

### SUMMARY OF THE INVENTION

It is an object of the present invention to provide a multi-compatible sizing composition that includes an epoxy resin emulsion containing a liquid epoxy resin emulsified by one or more surfactants, a coupling agent package that includes at least one vinyl silane and at least one aminosilane, a non-ionic lubricant, and a crystalline polyol. In preferred embodiments, the surfactant is one or more modified polyethylene oxide-polypropylene oxide copolymer surfactants, a mixture of modified and unmodified polyethylene oxide-polypropylene oxide copolymer surfactants, or two or more un-modified polyethylene oxide-polypropylene oxide copolymer surfactants. Condensation products of polyalkylene glycols with polyglycidyl ethers of bis-phenol A and alkylphenol polyethyoxylates may also be used to emulsify the epoxy resin. The epoxy resin is a low molecular weight epoxy resin that contains at least one epoxy or oxirane group. Additionally, the epoxy resin may have an epoxy equivalent weight from 170-235, and preferably an epoxy equivalent weight from 180-195. The low molecular weight crystalline polyol facilitates contact between the surface of the individual reinforcement fibers and the thermoset resin to improve the wet out of the reinforcement fibers. In preferred embodiments, the crystalline polyol is mono-pentaerythritol. Additives may also be included as a component of the size composition to impose desired properties or characteristics to the size composition and/or to the final product. The sizing composition may be used equally well with epoxy, unsaturated polyester, and vinylester thermosetting resins.

The multi-compatible sizing composition described above may be used to size a reinforcing fiber according to another object of the present invention. Reinforcement fibers sized with the inventive sizing composition possess low friction on contact points, which results in a low amount of broken filaments and/or fuzz and a reduction in drag. Additionally, mechanical properties such as in-plane shear and dynamic fatigue of products formed from reinforcement fibers sized with the inventive sizing composition are equal or superior to currently existing and most comparative products.

In a further object of the present invention, a woven fabric including a warp formed of first reinforcement fibers sized with a first sizing composition and a weft, generally perpendicular to the warp, formed of second reinforcement fibers sized with a second sizing composition is provided. Either or both of the first and second sizing composition may be the inventive multi-compatible sizing composition described above. The first and second reinforcement fibers may be the same or different, and may be formed of glass, polyester, polyamide, aramid, polyaramid, polypropylene, polyethylene, natural fibers, mineral fibers, carbon fibers, ceramic fibers, or mixtures thereof. The woven fabric may be formed into a laminate by immersing the woven fabric into a polymeric resin or by resin infusion to produce large, complex laminates used to reinforce composite products, such as windmill blades or boat hulls.

It is an advantage of the present invention that the epoxy resin emulsion present in the size composition is in a liquid form that reduces or eliminates the need for an organic solvent in the sizing composition. The reduction of organic solvents in the size in turn reduces the amount of volatile organic compounds that are emitted, thereby creating a safer, more environmentally friendly workplace.

It is another advantage of the present invention that the size composition provides equivalent or superior processing characteristics such as a low level of broken filaments (fuzz) and a reduction in drag.

It is a further advantage of the present invention that the sizing composition may be used equally well with epoxy, unsaturated polyester, and vinylester thermosetting resins and is thus multi-compatible.

It is yet another advantage of the present invention that composite articles formed utilizing the inventive sizing composition and an epoxy, unsaturated polyester, or vinylester resin possess equivalent or superior dynamic fatigue strength compared to conventional comparative products.

It is a feature of the present invention that the inventive size composition matches in-plane shear strengths of currently available composite products developed with epoxy, unsaturated polyester, and vinylester thermoset resins.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. The terms “sizing”, “size composition” and “sizing composition” may be used interchangeably herein. Additionally, the terms “film former” and film forming agent” may be used interchangeably. Further, the terms “reinforcing fiber” and “reinforcement fiber” may be used interchangeably.

The present invention relates to a sizing composition for reinforcement fibers. The sizing composition includes an epoxy resin emulsion, a silane coupling agent package that contains both an aminosilane and a vinyl silane, a lubricant, and a crystalline polyol. The epoxy resin emulsion includes an emulsified liquid epoxy resin. The sizing composition may be used equally well with epoxy, unsaturated polyester, and vinylester thermosetting resins. As such, the sizing composition is multi-compatible. Reinforcement fibers sized with the inventive sizing composition possess low friction on contact points, which results in a small amount of broken filaments and/or fuzz and a reduction in drag. Additionally, mechanical properties such as in-plane shear and dynamic fatigue of products formed from reinforcement fibers sized with the inventive sizing composition are equal to or superior than currently existing, comparative products (e.g., epoxy-compatible and multi-compatible).

The epoxy resin emulsion film former component of the sizing composition includes a low molecular weight epoxy resin that has been emulsified by one or more modified polyethylene oxide-polypropylene oxide (PEO-PPO) copolymer surfactants, a mixture of modified and unmodified polyethylene oxide-polypropylene oxide copolymer surfactants, or a plurality of unmodified polyethylene oxide-polypropylene oxide copolymer surfactants. Non-exclusive examples of suitable polyethylene oxide-polypropylene oxide copolymers include Pluronic PE10500 (a polyethylene oxide-polypropylene oxide copolymer), Pluronic P103 and Pluronic F77 (ethylene oxide/propylene oxide block copolymers), and Pluronic L101 (an ethylene oxide/propylene oxide block copolymer), all of which are available from BASF.

In addition, modified surfactants such as condensation products of polyalkylene glycols with polyglycidyl ethers of bis-phenol A may be used to emulsify the epoxy film former and form the epoxy resin emulsion. Suitable polyalkylene glycols include compounds such as copolymers of ethylene oxide and propylene oxide, polyethylene glycols, polypropylene glycols, polybutylene glycols, and monoalkyl ether derivatives thereof. Alkylphenol polyethyoxylates (APEs) may also be used as a surfactant in the size composition, but are not preferred due to the environmental and health/safety concerns that are associated with APE. Illustrative examples of suitable surfactants for use in the epoxy resin emulsion include Igepal CO 897 and Igepal CO 210, nonylphenolpolyethoxyethanols available from Stepan, and Triton X-100, an octylphenoxypolyethoxyethanol available from Dow Chemicals.

The film former functions to protect the fibers from damage during processing and imparts compatibility of the fibers with the matrix resin. In addition, film formers are agents which create improved adhesion between the reinforcing fibers, which results in improved strand integrity. In the inventive size composition, the film forming agent acts as a binding agent to provide additional protection to the reinforcing fibers and improve processability, such as a reduction in fuzz. In a preferred embodiment, a modified polyethylene oxide-polypropylene oxide copolymer surfactant is reacted with a low molecular weight liquid epoxy resin. This modified copolymer surfactant is, in turn, used to emulsify a low molecular weight epoxy resin as described below to form the epoxy resin emulsion film former.

With respect to the epoxy resin used in forming the modified epoxy resin film former, it is preferred that the epoxy resin have a molecular weight from 340-470 and an epoxy equivalent weight from 170-235, preferably a molecular weight 360-390 and an epoxy equivalent weight from 180-195, and most preferably a molecular weight from 360-384 and an epoxy equivalent weight from 185-192. “Epoxy equivalent weight”, as used herein, is defined by the molecular weight of the epoxy resin divided by the number of epoxy groups present in the compound. “Molecular weight” refers to weight average molecular weight. Useful epoxy resins contain at least one epoxy or oxirane group in the molecule, such as polyglycidyl ethers of polyhydric alcohols or thiols. Specific examples of suitable epoxy film forming resins for use in the inventive sizing composition include a bis-phenol A diglycidyl ether epoxy resins such as Epon® 828 (available from Hexion Specialties Chemicals Incorporated), DER 331 (available from Dow Chemicals), Araldite 6010 (available from Huntsman), and Epotuf 37-140 (available from Reichhold Chemical Co).

The low molecular weight epoxy resin emulsion (and epoxy resin) is preferably in a liquid form which reduces, and in some cases, eliminates the need for a solvent such as diacetone alcohol. This reduction of organic solvents in turn reduces the amount of volatile organic compounds (VOC's) that are emitted into the environment and thus provides a friendlier workplace. In addition, the low molecular weight epoxy film forming emulsions according to the present invention are substantially color free. As used herein, the term “substantially color free” means that there is minimal or no coloration of the epoxy emulsions.

The epoxy resin emulsion is present in the size composition in an amount of from about 50 to about 90% by weight solids and preferably from about 63 to about 77% by weight solids.

As discussed above, the size composition includes a non-ionic lubricant. Illustrative non-ionic lubricants include PEG 400 Monooleate, PEG 200 Monolaurate, PEG 600 Monooleate, PEG 600 Monostearate, PEG 400 Monostearate, and PEG 600 Monolaurate (all are polyethylene glycol fatty acid esters commercially available from Cognis), butoxyethyl stearate, ethyleneglycol oleates, and emulsified mineral oils. In a most preferred embodiment, the non-ionic lubricant is PEG 400 Monooleate. The non-ionic lubricant may be present in the size composition in an amount from about 15 to about 30% by weight solids, preferably from about 22.5 to about 27.5% by weight solids.

The sizing composition also includes a silane coupling agent package that includes an aminosilane and a vinyl silane coupling agent. The silane coupling agent package may be present in the size composition in an amount from about 5.5 to about 19.0% by weight solids, preferably in an amount from about 5.0 to about 8.6% by weight solids. When needed, an acid such as acetic acid, boric acid, metaboric acid, succinic acid, citric acid, formic acid, lactic acid, and/or phosphoric acid may be added to the size composition, such as, for example, to assist in the hydrolysis of the silane coupling agent.

Besides their role of coupling the film forming agent and/or the matrix resin to the surface of the reinforcing fibers, silanes also function to enhance the adhesion of the film forming component to the reinforcement fibers and to reduce the level of fuzz, or broken fiber filaments, during subsequent processing. Preferred examples of silane coupling agents which may be used in the present size composition may be characterized by the functional groups amino, epoxy, vinyl, methacryloxy, and ureido. Coupling agents for use in the silane package include silanes containing the structure R′Si(OR)₃, where R is an organic group such as an alkyl group. Lower alkyl groups such as methyl, ethyl, and isopropyl are preferred. Suitable aminosilane coupling agents for use in the size include, but are not limited to, aminopropyltriethoxysilane (A-1100 from GE Silicones), N-β-aminoethy-γ-aminopropyltrimethoxysilane (A-1120 from GE Silicones), N-phenyl-γ-aminopropyltrimethoxysilane (Y-9669 from GE Silicones), and bis-γ-trimethoxysilylpropylamine (A-1170 from GE Silicones). Preferably, the aminosilane coupling agent is a di-aminosilane such as N-β-aminoethyl-γ-aminopropyltrimethoxysilane (A-1120 from GE Silicones). The aminosilane coupling agent may be present in the size composition in an amount of from about 0.5 to about 4.0% by weight solids, preferably in an amount of from about 1.0 to about 1.6% by weight solids.

Non-exclusive examples of vinyl silanes that may be incorporated in the silane coupling package include γ-methacryloxypropyltrimethoxysilane (A-174 from GE Silicones), vinyltriethyoxy silane (A-151 from GE Silicones), vinyltrimethoxy silane (A-171 from GE Silicones), and vinyl tris (2-methoxy-ethoxy)silane (A-172 from GE Silicones). The vinyl silane coupling agent may be present in the size composition in an amount from about 5.0 to about 15.0% by weight solids, preferably in an amount from about 4.0 to about 7.0% by weight solids.

A low molecular weight crystalline polyol is also included in the sizing composition to facilitate the contact between the surface of the individual reinforcement fibers and the thermoset resin, thereby improving the wet-out of the reinforcement fibers. In preferred embodiments, the crystalline polyol is mono-pentaerythritol, and is present in the size composition in an amount from about 1.0 to about 1.5% by weight solids. Mono-pentaerythritol (i.e., 2,2-bis(hydroxymethyl)-1,3-propanediol) has the chemical formula C(CH₂OH)₄, and is described in detail in U.S. Pat. No. 5,262,236 to Brannon, which is hereby incorporated by reference by reference in its entirety. The crystalline polyol may be present in the sizing composition in an amount from about 0.5 to about 2.0% by weight solids, preferably in an amount from about 1.0 to about 1.5% by weight solids.

In addition, the size composition may optionally contain additives to impose desired properties or characteristics to the coating composition and/or to the final product. Non-exclusive examples of additives include wetting agents, pH adjusters, UV stabilizers, antioxidants, acid or base capturers, metal deactivators, processing aids, oils, lubricants, antifoaming agents, antistatic agents, thickening agents, adhesion promoters, compatibilizers, coupling agents, stabilizers, flame retardants, impact modifiers, pigments, dyes, colorants, odors, masking fluids, and/or fragrances. Additives may be present in the size composition in an amount up to about 5% by weight solids.

The size composition further includes water to dissolve or disperse the active solids for application onto the reinforcement fibers. Water may be added in an amount sufficient to dilute the aqueous sizing composition to a viscosity that is suitable for its application to the reinforcement fibers and to achieve a desired solids content on the fibers. In particular, the size composition may contain from about 93 to about 97% by weight of the total composition of water.

The range of components used in the inventive sizing composition is set forth in Table 1.

TABLE 1

| | % By Weight |
|---|---|
| Sizing Composition | Solids |
| Epoxy Resin Emulsion | 50-90 |
| Epoxy Resin | 40-70 |
| Emulsifier | 10-20 |
| Coupling Agent Package | 5.5-19.0 |
| Vinyl Silane Coupling Agent | 5-15 |
| Aminosilane Coupling Agent | 0.5-4.0 |
| Non-Ionic Lubricant | 15-30 |
| Crystalline Polyol | 0.5-2.0 |

A preferred aqueous sizing composition according to the present invention is set forth in Table 2.

TABLE 2

| | % By Weight |
|---|---|
| Sizing Composition | Solids |
| Epoxy Resin Emulsion | 63-77 |
| Epoxy Resin | 50-60 |
| Emulsifier | 13-17 |
| Coupling Agent Package | 5.0-8.6 |
| Vinyl Silane Coupling Agent | 4-7 |
| Aminosilane Coupling Agent | 1-1.6 |
| Non-Ionic Lubricant | 22.5-27.5 |
| Crystalline Polyol | 1.0-1.5 |

The size composition may be made by first mixing the aminosilane and vinyl silane coupling agents and the acid in water to hydrolyze the silanes. The water may be acidified. The epoxy resin emulsion is formed by emulsifying a low molecular weight epoxy resin with modified and/or unmodified surfactant(s). The aqueous hydrolyzed silane solution is then mixed with the epoxy resin film forming emulsion, non-ionic lubricant, and the crystalline polyol. In addition, any additives (if present) may be added to this mixture. Water is then added in an amount sufficient to achieve the appropriate concentration and control the mix of solids. Alternatively, the lubricant may be included with the epoxy resin film forming components where it acts as an inert diluent during the synthesis of the modified emulsifier and lowers the viscosity of the reaction medium.

The sizing composition may be used to treat a continuous reinforcing fiber. For example, the reinforcing fiber material may be one or more strands of glass formed by conventional techniques such as by drawing molten glass through a heated bushing to form substantially continuous glass fibers. These fibers may subsequently be collected into a glass strand. The size composition may be applied to the reinforcing fibers by any conventional method, including kiss roll, dip-draw, slide, or spray application to achieve the desired amount of the sizing composition on the fibers. Any type of glass, such as A-type glass, C-type glass, E-type glass, S-type glass, ECR-type glass fibers (e.g., Advantex® glass fibers available from Owens Corning), R-type glass fibers (e.g., Hiper-tex™ glass fibers available from Owens Corning), wool glass fibers, or combinations thereof may be used as the reinforcing fiber. Preferably, the reinforcing fiber is an E-glass, Advantex®, or Hiper-tex™ glass. The inventive sizing composition may be applied to the fibers with a Loss on Ignition (LOI) from 0.35 to about 0.90% on the dried fiber, preferably from about 0.45 to about 0.65%. As used in conjunction with this application, LOI may be defined as the percentage of organic solid matter deposited on the reinforcement fiber surfaces.

Alternatively, the reinforcing fiber may be strands of one or more synthetic polymers such as, but not limited to, polyester, polyamide, aramid, polyaramid, polypropylene, polyethylene, and mixtures thereof. The polymer strands may be used alone as the reinforcing fiber material, or they can be used in combination with glass strands such as those described above. As a further alternative, natural fibers, mineral fibers, carbon fibers, and/or ceramic fibers may be used as the reinforcement fiber. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber include cotton, jute, bamboo, ramie, bagasse, hemp, coir, linen, kenaf, sisal, flax, henequen, and combinations thereof.

The reinforcing fiber material may include fibers that have a diameter from about 6 microns to about 32 microns. In some embodiments, the fibers may have a diameter of more than 32 microns. Preferably, the fibers have a diameter from about 9 microns to about 28 microns. Most preferably, the fibers have a diameter from approximately 13 microns to approximately 24 microns. Each reinforcing fiber strand may contain from approximately 400 fibers to approximately 4000 fibers or more.

The size composition is especially suitable for fiber reinforcements (such as glass fibers) used in the production of prepregs, which may be made from a collection of unidirectional rovings or from fabrics. Such prepregs are pre-impregnated with a thermoset resin and remain in a pre-cure stage until they are stacked in several plies and cured by the composite manufacturer.

In addition, the size composition is advantageously used for fiber reinforcements (e.g., glass fibers) used in the production of fabrics. As used herein, the term “fabric” includes woven, stitched, knitted, needled, or braided products. Woven fabrics are produced by the interlacing of warp fibers (i.e., fibers orientated at 0°) and weft fibers (i.e., fibers at a 90° orientation (generally perpendicular) to the warp fibers) in a regular pattern or weave. In addition to woven rovings (i.e., bi-directional materials), the main types of fabrics formed are uniaxial, bi-axial (either 0° and 90° or +α and −α), tri-axial (generally +α and −α and either 0° or 90°), and quadriaxial (0°, 90°, +α, and −α), where α is an angle between 30° and 60°, and is most often 45°. These fabrics are usually stitched with a fine yarn that holds the various plies together, and may contain chopped, randomly applied fibers, chopped strand mat(s), continuous mat(s), and/or veil(s). Fiber orientation of individual plies and the construction or assembly of the various plies constitutes the major characteristics of the fabrics.

The woven fabric may be formed into a laminate by immersing the woven fabric into a polymeric resin or by resin infusion to produce large, complex laminates used to reinforce composite products, such as windmill blades or boat hulls. Suitable polymeric resins used in lamination processes include epoxy, unsaturated polyester, and vinylester thermoset resins, each of which is compatible with the inventive size composition.

The inventive size composition is particularly suitable for fabrics and laminates formed from fabrics for numerous reasons. For example, fabric production processes generally run at high speed and therefore require the reinforcement fiber packages to easily unwind. In addition, rovings made with the inventive size composition are directed through several guiding systems and tensioning devices that create abrasive contact points. The inventive size composition provides strength to the reinforcement fibers to reduce fiber breakage during the fabric production process so that little or no fuzz is generated. Further, rovings containing the inventive size composition have a good balance of drag resistance and slipperiness to run smoothly in the guiding systems and also open easily for a fast impregnation with the resin. With the inventive sizing composition, particularly good and fast wet-out is achieved because the size composition provides relatively limited integrity to the fibers within the rovings. As used herein, “limited integrity” means that the collection of individual filaments of the roving can be easily opened by passing the roving over a set of spreader bars, which allows resin penetration in between and among the individual filaments and a thorough impregnation of the roving.

The size composition may be used to coat fibers used to form thermoset composite articles. Reinforcement fibers sized with the inventive sizing composition can be mixed with an epoxy, unsaturated polyester, or vinylester thermosetting resin. The reinforcement fibers can be in the form of a monofilament or multifilament strand as either essentially continuous strands or chopped strands, depending on the shape and method of fabrication of the article to be formed. Sized reinforcement fibers (e.g., glass, carbon, aramid, or other high stiffness fibers) in the form of long continuous strands are particularly useful in forming composite articles by a pultrusion process, where the continuous fibers are pulled through a die in which the fibers are impregnated with a resin and the resin-fiber combination is shaped into a profile that can be used to manufacture the continuous fiber composite profiles to any suitable cross-sectional shape.

Additionally, the sizing composition may be advantageously employed to coat the fibers used in a filament winding application. For example, the fibers may be coated or treated with the sizing composition and formed into a roving in a conventional manner. The sized roving may then be wound onto a mandrel. The mandrel may be any conventional mandrel such as a reusable mandrel, a collapsible mandrel, an integral mandrel, or a sacrificial mandrel. Once the roving has been wound about the mandrel, the composite part and mandrel are heated, such as by passing the composite part/mandrel through an oven or by passing hot air or steam through the mandrel. Once the composite is cured and cooled, the mandrel may be removed. Composite parts such as pipes or tanks made from fibers sized with the size composition of the present invention demonstrate superior strength and superior processing characteristics such as faster impregnation of the strand with the resin, a reduced amount of broken filaments, and a smoother surface of the pipe.

One advantage of the inventive size composition is the ability of the size composition to reduce drag. A reduction in drag in the sized glass fibers permits the manufacturers to run their production lines at a faster rate than with a glass fiber that has a high drag. As a result, an increase in the productivity may be achieved with the inventive sizing composition. The reduction in drag in turn causes a reduction in fuzz, or broken fibers, that occurs as the final products are being made. The occurrence of fuzz may cause some manufacturing downtime and may result in a product with a rough surface, which is not aesthetically pleasing. In addition, the reduction in drag reduces the amount of the sizing composition that is deposited onto the contact points from the glass fibers during processing.

Another advantage of the sizing composition is its multi-compatibility with more than one matrix resin, namely, epoxy, unsaturated polyester, and vinylester resins. It has been determined that the inventive size composition matches the in-plane shear strengths of currently available composite products developed for these thermoset resins. It is to be appreciated that in-plane shear strengths are the best indication of adhesion quality between the reinforcement fibers and the matrix resin. Thus, manufacturers, especially the fabric and prepreg producers, are able to use one sizing composition for all applications that utilize an epoxy, unsaturated polyester, or vinylester resin.

Additionally, composite articles formed utilizing the inventive sizing composition and an epoxy, unsaturated polyester, or vinylester resin posses superior dynamic fatigue strength in in-plane shear. As a result, products requiring high shear strength such as windmill blades and boat hulls may be formed with fabric or prepregs utilizing the sizing composition of the present invention.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Testing for the Occurrence of Fuzz on Glass Fibers Sized with the Inventive Sizing Composition

The size composition set forth in Table 3 was prepared and applied to glass fibers having a diameter of 17 microns and a bundle tex of 1200 by conventional techniques. Acetic acid was used to assist in the hydrolyzation of the coupling agents. The acetic acid was eliminated from the size composition by drying the fiber. The size composition was applied to the fibers in an amount sufficient to achieve a Loss on Ignition (LOI) of 0.45±0.05%. The sized fibers were then dried in a conventional manner at a temperature and for a time sufficient to both dry and cure the sizing on the glass fibers.

TABLE 3
Size Composition A

| | % By Weight |
|---|---|
| Sizing Composition | Solids |
| Epoxy Resin Emulsion | 66.8 |
| Epoxy Resin^{(a)} | 52.8 |
| Emulsifier^{(b)} | 14.0 |
| Coupling Agent Package | 6.9 |
| Vinyl Silane Coupling Agent^{(c)} | 5.3 |
| Aminosilane Coupling Agent^{(d)} | 1.6 |
| Non-Ionic Lubricant^{(e)} | 25.0 |
| Crystalline Polyol^{(f)} | 1.30 |

^{(a)}Epon ® 828 (a bis-phenol A diglycidyl ether epoxy resin (Hexion Specialties Chemicals Incorporated)
^{(b)}Pluronic 10500 (available from BASF) reacted with Epon ® 828 (6.5 weight % Epon ® 828 vs. Pluronic 10500) in the presence of BF₃ (etherate catalyst (1%))
^{(c)}A-174 (γ-methacryloxypropyltrimethoxysilane available from GE Silicones)
^{(d)}A-1120 (N-β-aminoethyl-γ-aminopropyltrimethoxysilane available from GE Silicones)
^{(e)}PEG 400 Monooleate (available from Cognis)
^{(f)}mono-pentaerythritol

The glass fibers sized with Size Composition A set forth in Table 3 were tested by an internally designed test for determining the occurrence of fuzz, also known as a “Severity Test”. In particular, a roving was driven at a speed of 80 meters/min into a box (the “fuzz box”) containing a set of three spreader bars (formed of a Tital® ceramic material) having diameters of 19 mm mounted parallel to each other at a distance of 100 mm from each other in the same plane. The roving was lead back and forth five times into the fuzz box successively above and below each spreader bar. Inside the fuzz box, the roving additionally passed through a slot formed by a steel comb having a clearance of 0.4 mm. The fuzz box was submitted to a vacuum through a fine screen that collected all of the fuzz created by broken filaments. The amount of fuzz was measured in milligrams after 5 minutes.

Glass fibers sized with Control 1, which is the closest current epoxy compatible product for enhanced fatigue performance from Owens Corning as set forth in U.S. Pat. No. 6,270,897 to Flautt, et al. issued on Aug. 7, 2001 entitled “Coupling-Agent System For Composite Fibers” (expressly incorporated by reference in its entirety) and Control 2, which is a current and commercially available epoxy, polyester, and vinylester resin compatible product, were tested in the same manner described above and compared to the glass fibers sized with Size Composition A.

The results of the experiments are set forth in Table 4.

TABLE 4

| Sample | Fuzz (mg/5 min) |
|---|---|
| Inventive Size Composition A | 14 |
| Control 1 | 36 |
| Control 2 | >100 |

As shown in Table 4, glass fibers sized with inventive Size Composition A demonstrated the lowest occurrence of fuzz generated by the glass fibers passing through the contact points. This significant reduction in the amount of fuzz produced by glass fibers sized with inventive Size Composition A demonstrates an improvement in processability for the inventive size composition over the each of the controls. Fuzz is an undesirable feature in both fabric and prepreg production as well as in the manufacturing of parts, and thus the ability of a glass fiber to demonstrate low fuzz occurrence has a clear market advantage. The low fuzz generated by fibers sized with Size Composition A permits fabric and prepreg manufacturers to be able to run their production line at a fast rate with little to no breakage of the fibers. In addition, the reduction in fuzz on the glass fibers sized with Size Composition A will result in a product that has a smoother surface and that is aesthetically pleasing. Further, less maintenance of the production lines will occur with a reduction in the occurrence of fuzz because the contact points would need to be cleaned less frequently.

### Example 2

### Testing For Drag of Sized Glass Fibers

Glass fibers sized with inventive Size Composition A set forth in Table 3, glass fibers sized with Control 1, and glass fibers sized with Control 2 as described in Example I were tested to determine the amount of drag (i.e., frictional resistance) generated by the glass fibers. The testing was conducted by running the glass fibers through a set of 12 parallel spreader bars set 10 mm apart from each other at a speed of 40 feet (12 meters) per minute. Each of the spreader bars had a diameter of 5 mm. A tension meter was positioned at a location after the 12^{th} contact point to measure the tension of the glass fibers. Tension was recorded over a time period of 5 minutes.

TABLE 5

| | Average Drag Force |
|---|---|
| Sample | (Newton) |
| Inventive Size Composition A | 52 |
| Control 1 | 53 |
| Control 2 | Approximately 100 |

The data set forth in Table 5 demonstrates the low dynamic tension (i.e., low frictional resistance or drag) that occurs in the glass fibers sized with inventive Size Composition A. As shown in Table 5, the glass fibers sized with the inventive size composition had a significantly lower drag force than Control 2 and a similar drag force to Control 1. The significant reduction in drag in glass fibers sized with inventive Size Composition A over Control 2 demonstrates an improvement in the processability of fibers sized with inventive Size Composition A. Low drag is a desired property in sized glass fibers. A reduction in drag such as is caused by inventive Size Composition A permits manufacturers to run their production lines at a faster rate than with a glass fiber that has a high drag, which increases their productivity.

### Example 3

### Testing For Static 45° In-Plane Shear-Tensile Strength With An Epoxy Laminate

Laminates were formed by applying a series of alternating layers at both 0° and 90° by winding a dry roving onto a flat square plate used as a mandrel. Once a [0°/90°]₄ orthogonal laminate was constructed, the laminate was impregnated by resin infusion under vacuum between thick glass plates. The epoxy resin utilized was MGS L135i with 35 pph (in weight) of MGS L137 hardener (Hexion Martin-Sheuffler). The epoxy resin was infused at 35° C. under a vacuum of 0.035 bars at absolute pressure. This testing procedure produced virtually flawless laminates with low void content, perfect or nearly perfect fiber alignment, and well-controlled thickness and glass content. After curing the laminate for 18 hours at 35° C. with a post-cure of 4 hours at 90° C., test coupons (specimens) were then cut precisely in the 45° direction of the laminates for tensile testing. The average of the test results are set forth in Table 6.

In addition, the translucency of the laminates was measured by determining the amount of light transmitted through each of the laminates. A higher light translucency indicates a better quality of impregnation by the resin. The amount of light transmitted for inventive Size Composition A was determined to be 710 lux. Control 1 had a translucency of 705 lux and a few visual defects such as fiber streaks. Control 2 had a translucency of 588 lux.

TABLE 6

| | Average 45° Shear-Tensile |
|---|---|
| Sample | (MPa) |
| Inventive Size Composition A | 141 |
| Control 1 | Average 139-144 |
| Control 2 | 145 |

As shown in Table 6, it can be seen that the average in-plane static shear strength is similar for both Control 1 and Control 2, both of which are the current most comparative epoxy-compatible rovings. Additionally, the average in-plane shear strength of inventive Size Composition A is comparable to both Control 1 and Control 2. As such, it can be concluded that the laminates formed utilizing inventive Size Composition A had an in-plane shear strength equal to or better than conventional epoxy-compatible laminates.

### Example 4

### Testing For Dynamic Fatigue 450 In-Plane Shear-Tensile Strength With Epoxy Laminate

Laminates were formed in the same manner as described above in Example 3, and samples were taken at precisely a 45° from the 0°/90° filament wound laminates. The samples were submitted to dynamic fatigue tests following the testing procedures set forth in ISO 13003 under alternating tensile and compressive loads with a stress ratio of R=−1 (i.e., where the compression stress and tension stress are equal in absolute value). In order to draw the regression line of stress level as a function of time (or cycles) to failure, several samples were tested at various stress levels until the laminate failed (broke). At least 12 failure data points were obtained for laminates up to at least 200,000 cycles so that a regression line could be drawn and the extrapolated value of the failure stress level at 1 million cycles could be obtained. The higher the extrapolated stress level, the better the fatigue resistance in in-plane shear. Table 7 illustrates the dynamic fatigue strengths that were extrapolated for 1 million cycles for inventive Size Composition A and Control 1 and Control 2, both of which are currently existing and comparative epoxy-compatible products.

TABLE 7

| | Average Dynamic 45° |
|---|---|
| Sample | Shear-Tensile Value (MPa) |
| Inventive Size Composition A | 26.73 |
| Control 1 | 23.84 |
| Control 2 | 23.55 |

The results set forth in Table 7 demonstrate that the inventive sizing composition has a 12-13.5% higher long term strength to failure under dynamic fatigue. A high strength to failure is important for applications that require good dynamic fatigue performance in alternating load conditions, such as windmill blades.

### Example 5

### Testing For Static 45° Shear-Tensile For Polyester Laminate

Bi-directional laminates were formed in the same manner as described above in Example 3 with the exception that a specific grade of polyester resin from Reichhold was utilized instead of the epoxy resin. Curing agents for this resin system were 1.5% Norpol Peroxide 18 and 0.15% NLCIO inhibitor. The infusion of the polyester resin was conducted at room temperature under an absolute pressure of 0.035 bars. Curing was conducted at room temperature for 24 hours, followed by a post cure for 12 hours at 60° C. Samples were then cut at 45° in the bi-directional laminates and tested for tensile strength to obtain the in-plane shear strength following the testing procedures set forth in ISO 14129.

Glass fibers sized with inventive Size Composition A set forth in Table 3 and glass fibers sized with Control 3 and Control 4 (commercially available epoxy, polyester, and vinylester resin compatible size compositions) were tested to determine the static 45° in-plane shear-tensile strength for polyester laminates formed according to the procedure set forth above. The results are set forth in Table 8.

TABLE 8

| | Average 45° |
|---|---|
| Sample | Shear-Tensile Value (MPa) |
| Inventive Size Composition A | 79.9 |
| Control 3 | 79.0 |
| Control 4 | 71.8 |

The results in Table 8 demonstrate that inventive Size Composition A provides at least equivalent shear strength to Control 3 and a significantly superior shear strength to Control 4. These results indicate that inventive Size Composition A not only provides good performance in epoxy resins, but also in polyester resins, thus proving that the inventive size composition is multi-compatible.

### Example 6

### Testing For Static 45° Shear-Tensile For Polyester Laminate

Laminates were formed by the procedure set forth in Example 3 with the exception that the polyester resin and cure system as described in Example 5 were utilized instead of the epoxy resin and accompanying cure system. Samples were cut at 45° through the [0°/90°]₄ bidirectional laminates for dynamic fatigue testing following the testing procedures set forth in ISO 13003 under alternating tensile and compressive loads with a stress ratio of R=−1. A regression line was drawn through a set of at least 12 failure points extending up to at least 200,000 cycles in order to extrapolate to 1 million cycles. The extrapolated in-plane shear values at 1 million cycles are provided in Table 9.

TABLE 9

| | Average Dynamic 45° |
|---|---|
| Sample | Shear-Tensile Value (MPa) |
| Inventive Size Composition A | 21.6 |
| Control 3 | 21.5 |
| Control 4 | 19.4 |

The data obtained and set forth in Table 9 indicates that inventive Size Composition A provides equal or superior long term dynamic fatigue strength in in-plane shear compared to existing multi-compatible products Control 3 and Control 4, the closest commercial multi-compatible products in their own field of application.

The results from Examples 1-6 show that the inventive size composition forms a glass fiber roving that produces a limited amount of fuzz and low friction drag. Therefore, fibers sized with the inventive sizing composition have the capability to smoothly produce prepregs and fabrics with reduced production and maintenance costs. Because the inventive size composition is multi-compatible, it is believed that the size composition is likely to permit fabric producers to use a single size composition instead of various, single component size compositions (e.g., epoxy compatible and polyester compatible) for numerous applications. This would result in substantial cost savings in heavy labor and a reduction in the amount of down time to change hundreds of roving packages in their creels to switch from one product to another.

In addition, the mechanical properties, especially the in-plane shear strengths, of products formed using the inventive size composition are equal or substantially equal to or exceed the mechanical properties of the most comparable commercial products in epoxy products using epoxy resins and multi-compatible products using polyester resins. In dynamic fatigue, the inventive size composition was shown to provide 12-13.5% better performance than the closest epoxy-compatible products pre-impregnated with an epoxy resin and up to 13% better long term fatigue strength than commercially available multi-compatible products impregnated with a polyester resin.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A multi-compatible sizing composition comprising:
an epoxy resin emulsion including a liquid epoxy resin emulsified by one or more surfactants;
a coupling agent package including at least one vinyl silane and at least one aminosilane;
a non-ionic lubricant; and
a crystalline polyol.

2. The multi-compatible sizing composition of claim 1, wherein said epoxy resin has an epoxy equivalent weight from 170-235.

3. The multi-compatible sizing composition of claim 1, wherein said one or more surfactants is selected from a modified polyethylene oxide-polypropylene oxide copolymer, a mixture of modified polyethylene oxide-polypropylene oxide copolymers, a mixture of modified and unmodified polyethylene oxide-polypropylene oxide block copolymers, two or more unmodified polyethylene oxide-polypropylene oxide copolymers, alkylphenol polyethyoxylates, copolymers of ethylene oxide and propylene oxide, polyethylene glycols, polypropylene glycols, polybutylene glycols and monoalkyl ether derivatives thereof.

4. The multi-compatible sizing composition of claim 3, wherein said aminosilane is selected from aminopropyltriethoxysilane, N-β-aminoethyl-γ-aminopropyltrimethoxysilane, N-phenyl-γ-aminopropyltrimethoxysilane and bis-γ-trimethoxysilylpropylamine; and
wherein said vinyl silane is selected from γ-methacryloxypropyltrimethoxysilane, vinyltriethyoxy silane and vinyl tris (2-methoxy-ethoxy)silane.

5. The multi-compatible sizing composition of claim 1, wherein said surfactant is a modified polyethylene oxide-polypropylene oxide copolymer, said aminosilane is a di-aminosilane, said vinyl silane is γ-methacryloxypropyltrimethoxysilane, and said crystalline polyol is mono-pentaerythritol.

6. The multi-compatible sizing composition of claim 1, wherein:
said epoxy resin emulsion is present in said sizing composition in an amount from about 50 to about 90% by weight solids;
said coupling agent package is present in said sizing composition in an amount from about 5.5 to about 19.0% by weight solids;
said non-ionic lubricant is present in said sizing composition in an amount from about 5.0 to about 15.0% by weight solids; and
said crystalline polyol is present in said sizing composition in an amount from about 0.5 to about 2.0% by weight solids.

7. A sized reinforcement fiber comprising:
a reinforcement fiber at least partially coated with a sizing composition compatible with epoxy, unsaturated polyester, and vinylester thermosetting resins, said sizing composition including:
an epoxy resin emulsion including an emulsified liquid epoxy resin;
at least one vinyl silane;
at least one aminosilane;
a non-ionic lubricant; and
a crystalline polyol.

8. The sized reinforcement fiber of claim 7, wherein said emulsified liquid epoxy resin is emulsified by an emulsifying agent selected from a modified polyethylene oxide-polypropylene oxide copolymer surfactant, a mixture of modified polyethylene oxide-polypropylene oxide copolymer surfactants, a mixture of modified and unmodified polyethylene oxide-polypropylene oxide block copolymer surfactants, two or more un-modified polyethylene oxide-polypropylene oxide copolymer surfactants, alkylphenol polyethyoxylates, copolymers of ethylene oxide and propylene oxide, polyethylene glycols, polypropylene glycols, polybutylene glycols and monoalkyl ether derivatives thereof.

9. The sized reinforcement fiber of claim 8, wherein said epoxy resin has an epoxy equivalent weight from 170-235.

10. The sized reinforcement fiber of claim 9, wherein said emulsifying agent is a modified polyethylene oxide-polypropylene oxide copolymer, said aminosilane is a di-aminosilane, said vinyl silane is γ-methacryloxypropyltrimethoxysilane, and said crystalline polyol is mono-pentaerythritol.

11. The sized reinforcement fiber of claim 8, wherein said epoxy resin is a bis-phenol A diglycidyl ether epoxy resin.

12. The sized reinforcement fiber of claim 8, wherein said aminosilane is selected from aminopropyltriethoxysilane, N-β-aminoethyl-γ-aminopropyltrimethoxysilane, N-phenyl-γ-aminopropyltrimethoxysilane and bis-γ-trimethoxysilylpropylamine; and
wherein said vinyl silane is selected from γ-methacryloxypropyltrimethoxysilane, vinyltriethyoxy silane and vinyl tris (2-methoxy-ethoxy)silane.

13. The sized reinforcement fiber of claim 7, wherein:
said epoxy resin emulsion is present in said sizing composition in an amount from about 50 to about 90% by weight solids;
said aminosilane coupling agent is present in said sizing composition in an amount from about 0.5 to about 4.0% by weight solids;
said vinyl silane coupling agent is present in said sizing composition in an amount from about 5.0 to about 15.0% by weight solids;
said non-ionic lubricant is present in said sizing composition in an amount from about 5.0 to about 15.0% by weight solids; and
said crystalline polyol is present in said sizing composition in an amount from about 0.5 to about 2.0% by weight solids.

14. A woven fabric comprising:
a warp formed of first reinforcement fibers sized with a first sizing composition; and
a weft, generally perpendicular to said warp, formed of second reinforcement fibers sized with a second sizing composition, said first and second reinforcement fibers being the same or different;
wherein one or both of said first sizing composition and said second sizing composition is a multi-compatible sizing composition including:
an epoxy resin emulsion including an epoxy resin emulsified by one or more surfactants;
a coupling agent package including at least one vinyl silane and at least one aminosilane;
a non-ionic lubricant; and
a crystalline polyol.

15. The woven fabric of claim 14, wherein said one or more surfactants is selected from a modified polyethylene oxide-polypropylene oxide copolymer, a mixture of modified polyethylene oxide-polypropylene oxide copolymers, a mixture of modified and unmodified polyethylene oxide-polypropylene oxide block copolymers, two or more un-modified polyethylene oxide-polypropylene oxide copolymers, alkylphenol polyethyoxylates, copolymers of ethylene oxide and propylene oxide, polyethylene glycols, polypropylene glycols, polybutylene glycols and monoalkyl ether derivatives thereof.

16. The woven fabric of claim 14, wherein said epoxy resin has an epoxy equivalent weight from 170-235.

17. The woven fabric of claim 16, wherein said epoxy resin is a bis-phenol A diglycidyl ether epoxy resin.

18. The woven fabric of claim 16, wherein said aminosilane is selected from aminopropyltriethoxysilane, N-β-aminoethyl-γ-aminopropyltrimethoxysilane, N-phenyl-γ-aminopropyltrimethoxysilane and bis-γ-trimethoxysilylpropylamine; and
wherein said vinyl silane is selected from γ-methacryloxypropyltrimethoxysilane, vinyltriethyoxy silane and vinyl tris (2-methoxy-ethoxy)silane.

19. The woven fabric of claim 14, wherein said one or more surfactants is a modified polyethylene oxide-polypropylene oxide copolymer, said aminosilane is a di-aminosilane, said vinyl silane is γ-methacryloxypropyltrimethoxysilane, and said crystalline polyol is mono-pentaerythritol.

20. The woven fabric of claim 14, wherein:
said epoxy resin emulsion is present in said multi-compatible sizing composition in an amount from about 50 to about 90% by weight solids;
said coupling agent package is present in said multi-compatible sizing composition in an amount from about 5.5 to about 19.0% by weight solids;
said non-ionic lubricant is present in said multi-compatible sizing composition in an amount from about 5.0 to about 15.0% by weight solids; and
said crystalline polyol is present in said multi-compatible sizing composition in an amount from about 0.5 to about 2.0% by weight solids.

21. The woven fabric of claim 19, wherein said multi-compatible sizing composition is compatible with epoxy, unsaturated polyester, and vinylester thermosetting resins.
